(19) United States
(12) Patent Application Publication
(10) Pub. No.: US 2006/0273530 A1
(43) Pub. Date: Dec. 7, 2006

(54) WHEEL GUIDANCE

(75) Inventor: ARMIN ZUBER, Meckesheim (DE)

Correspondence Address: Henry M. Feiereisen;Henry M. Feiereisen, LLC, Suite 4714, 350 Fifth Avenue, New York, NY, 10118, US

(73) Assignee: Benteler Automobiltechnik GmbH, Paderborn (DE)

(21) Appl. No.: 11/421,899

(22) Filed: Jun. 2, 2006

(30) Foreign Application Priority Data
Jun. 3, 2005 (DE) 10 2005 026 047.0

(51) Int. Cl. B60G 7/00; B60G 17/056; B60G 11/18

(52) U.S. Cl. 280/5.52; 280/86.75; 280/124.13; 280/5.5

(57) ABSTRACT

A wheel guidance includes at least one bearing for articulation of a trailing arm or wishbone to a vehicle body. Oscillations caused during travel are detected by a sensor and superimposed by a compensation oscillation generated by a controller in combination with linear motors to provide oscillation damping.

### CROSS-REFERENCES TO RELATED APPLICATIONS

This application claims the priority of German Patent Application, Serial No. 10 2005 026 047.0, filed Jun. 3, 2005, pursuant to 35 U.S.C. 119(a)-(d), the content of which is incorporated herein by reference.

### BACKGROUND OF THE INVENTION

The present invention relates, in general, to a wheel guidance.

Nothing in the following discussion of the state of the art is to be construed as an admission of prior art.

Increasingly, consumers demand from a wheel guidance to provide more riding comfort, less oscillation buildup, less noise development and longer service life. A wheel guidance may be constructed as independent wheel suspension or in the form of twist-beam axle or rigid axle. Typical components of a wheel guidance include guide rods and bearings. The guide rods provide wheel guidance and are connected via bearings to the vehicle body as well as wheel carrier. Bearings are differentiated between supporting joints and guiding joints. Vertical forces are predominantly transmitted across the supporting joints which normally are constructed as maintenance-free ball-and-socket joints having a ball which slides in a plastic socket that is constantly lubricated. Guiding joints for resisting forces may include for noise insulation rubber or plastic elements which are vulcanized or pressed between attachment parts.

Track stabilization involves the use of elasticities which are present in any wheel guidance. As a result, the wheel position can be influenced by the bearings in dependence on the situation at hand. This is utilized for example in bearings for track correction where lateral forces cause a steering effect when traveling along a curve. As a consequence, the self-steering property is improved. The provision of rubber elements in the bearings damps a major part of the oscillations of the wheel guidance. Still, there remain some oscillations that are transmitted to the vehicle body and objected by the occupant to adversely affect the riding comfort.

German Offenlegungsschrift DE 199 15 214 A1 discloses an individual wheel suspension with several guide rods, of which two have points of articulation that can be actively adjusted in relation to the vehicle body. Two substantially horizontal spindles are hereby provided and define axes in which the points of articulation can be shifted with the aid of electric motors.

European Patent Application EP 1 216 859 shows a twist beam axle which can be actively controlled by a linear actuator.

U.S. Pat. No. 4,900,054 discloses a vehicle chassis having a guide rod. Associated to the guide rod is an electromagnetic arrangement with a runner and two stators. The runner is able to move rectilinear through the stator. Oscillations by the chassis are influenced by controlling the electromagnetic arrangement.

German Offenlegungsschrift DE 100 00 390 A1 discloses an arrangement of a bearing on a running gear part. The bearing includes two parallel bearing parts with aligned pivot axes. A piezoelectric element is provided between first and second bearing parts of each bearing for actively influencing the bearing.

It would be desirable and advantageous to provide an improved wheel guidance to obviate prior art shortcomings and to afford enhanced riding comfort.

### SUMMARY OF THE INVENTION

According to one aspect of the present invention, a wheel guidance includes at least one bearing for articulation of a trailing arm or cross member to a vehicle body, an active arrangement, operatively connected to the bearing and having a plurality of linear motors, for chassis manipulation and oscillation damping, said linear motors being constructed to operate in different directions, with the linear motors being constructed to act in different directions, and a controller operatively connected to the linear motors.

The present invention resolves prior art problems by constructing an active arrangement with several linear motors that operate in separate directions. In this way, the active arrangement is able to suit the chassis during travel to road and traffic conditions at hand as well as to the properties of the vehicle. This can be realized in particular by altering the chassis manipulations, such as track values for example. Oscillation of the trailing arm or wishbone during travel can be detected by a sensor assembly and damped by an actively generated compensation oscillation to effectively neutralize or shift the oscillation to a higher frequency range in particular. The active arrangement adapts and intervenes actively to generate static as well as periodic shifts of a bearing axis for example. Static shifts cause track adjustment whereas periodic shifts in suitable phase position effect a suppression of oscillations or a frequency damping. In addition, the active arrangement is able to uncouple the wheel guidance from the vehicle body so that this measure provides also an effective measure to damp oscillations. Transmission of oscillations, especially high-frequency oscillations, from the wheel guidance to the vehicle body is eliminated.

The effect of the active arrangement is thus based on a damping of wheel-side oscillations, shift thereof to other frequency ranges, and/or uncoupling of the wheel guidance from the vehicle body. Vibrations and noise can thus be suppressed. As a consequence, the riding comfort and safety are improved.

The linear motors are provided to generate translatory movements and exhibit high positional accuracy as well as high acceleration capability. The linear motors may operate on the principle of electromagnetic, hydraulic, pneumatic, or piezoelectric drives.

As the plurality of linear motors operate in different directions, oscillations of the wheel guidance can thus be compensated not only in one direction, for example in transverse direction to the length axis of the bearing, but also in other directions.

Various physical systems can be used to implement the active oscillation damping and may include components such as actuators and/or sensors that can be activated electrically. Of course, existing wheel guidances can be retrofitted with an active arrangement according to the invention.

According to another feature of the present invention, the active arrangement may include at least one acceleration sensor which is secured to the vehicle body. Suitably, the acceleration sensor is operatively connected to a controller for signal transmission. To detect accelerations in several spatial directions X, Y, Z, the active arrangement to influence the chassis and to damp oscillations may also include several acceleration sensors. The close proximity of the acceleration sensors to the vehicle body allows a detection of vibrations at the site where the vibrations should be suppressed. This greatly simplifies the construction of the active arrangement.

According to another feature of the present invention, the active arrangement may include spring members for interaction with the linear motors. The spring members may be placed in parallel or in series to the linear motors. Examples of spring members include rubber springs, helical springs, or leaf springs, as well as pneumatic or hydraulic dampers. The spring members may be mounted on one side or on both sides of a bearing axle in a direction parallel to the length axis of the linear motors.

According to another feature of the present invention, the linear motors are constructed to operate on the basis of an electromagnetic propulsion principle. Linear motors of this type have a primary part, which is current-carrying, and a secondary part, the so-called reactive part, which supports permanent magnets. Suitably, the secondary of each linear motor is coupled to the bearing axle.

According to another feature of the present invention, the linear motors may include, as an alternative, piezoceramic actuators. Piezoceramic actuators convert electric energy into mechanical energy in the absence of moving parts and are thus able to quickly react over an extended service life. The operation of piezoelements is based on the principle that embedded crystals change their shape when subjected to an electric field. As a result, the piezoelements can be actively excited by an external controller. The piezoelectric elements then cause the bearing to generate the counter or compensation oscillation directly on the wheel guidance. Suitably, the piezoceramic actuators form a staple actuator.

According to another feature of the present invention, the active arrangement can be constructed for adjustable control characteristics. In this way, a vehicle operator is able to directly influence any noise development or occurrence of vibrations by actuating respective switches or variable transformers, in order to realize a sporty feel.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a top view of a first embodiment of a wheel guidance according to the present invention;

FIG. 2 is a top view of a second embodiment of a wheel guidance according to the present invention;

FIG. 3 is a detailed cutaway view, on an enlarged scale, of an integrated active arrangement for chassis manipulation and oscillation damping; and

FIG. 4 is a detailed cutaway view, on an enlarged scale, of an external active arrangement for chassis manipulation and oscillation damping.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

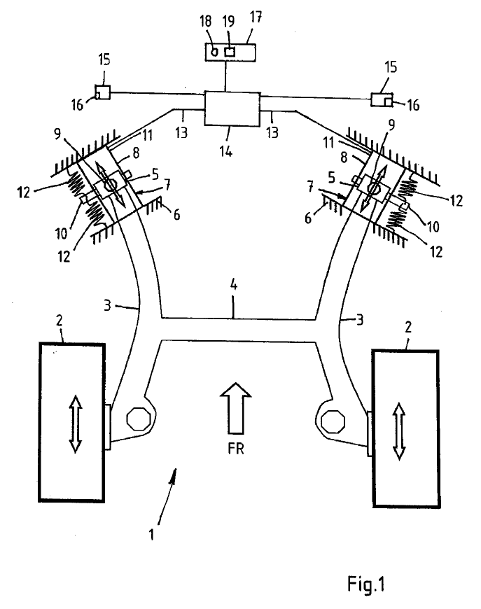

Turning now to the drawing, and in particular to FIG. 1, there is shown a top view of a first embodiment of a wheel guidance according to the present invention, generally designated by reference numeral 1 and constructed as twist beam axle. The wheel guidance 1 provides guidance of wheels 2 which are caused to vibrate when traveling on a road surface. The travel direction is indicated by arrow FR. The wheel guidance 1 includes two trailing arms 3 and a wishbone 4. The trailing arms 3 are mounted to a vehicle body 6 by means of two bearings 5. Each bearing 5 is operatively connected to an active arrangement, generally designated by reference numeral 7, for chassis manipulation and oscillation damping. The active arrangements 7 include electromagnetic linear motors 8 having reactive parts 9, which are coupled to the anchor pins 10 of the bearings 5, and primary parts 11, which are coupled to the vehicle body 6. Further provided at each bearing 5 are two coil springs 12 which are placed in parallel relationship to the active arrangement 7. Of course, the provision of coil springs is done by way of example only, and other types of resilient structures such as rubber springs or leaf springs may also be used.

The coil springs 12 of each bearing 5 have a common length axis and are positioned on both sides of the respective anchor pin 10. The coil springs 12 link the anchor pins 10 to the vehicle body 6. The active arrangement 7 in concert with the coil springs 12 forms a spring/damper unit.

The linear motors 8 are connected to a controller 14 via wire connections 13. The controller 14 is operatively connected to two sensor units 15 for signal transmission. The sensor units 15 are mounted to the vehicle body 6 in close proximity of the bearings 5. Each sensor unit 15 includes an acceleration sensor 16 for detecting acceleration in length directions of the trailing arms 3. The controller 14 is further operatively connected to a control unit 17 which allows an operator to adjust the control behavior of the active arrangement 7 via a variable transformer 18 and a switch 19.

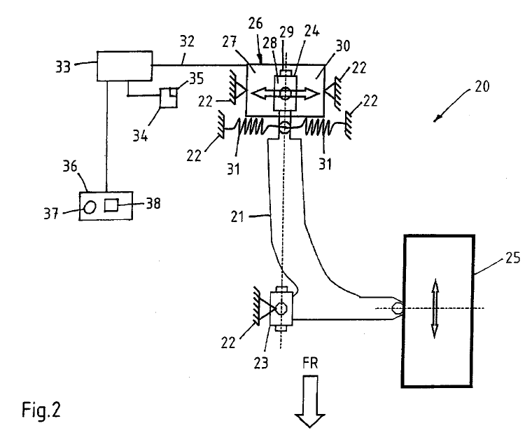

Referring now to FIG. 2, there is shown a top view of a second embodiment of a wheel guidance according to the present invention, generally designated by reference numeral 20 and designed as McPherson axle. A wishbone 21 is connected to a vehicle body 22 via a supporting joint 23 and a guiding joint 24 for guiding a wheel 25. The travel direction is indicated by arrow FR, with the supporting joint 23 having a length axis pointing in travel direction FR. The wheel 25 is caused to vibrate when driving on a road surface. Operatively connected to the guiding joint 24 is an active arrangement, generally designated by reference numeral 26, for chassis manipulation and oscillation damping. The active arrangement 26 has an electromagnetic linear motor 27 which includes a reactive part 28 coupled to the guiding joint 24, and a primary part 30. The guiding joint 24 is hereby placed upon a pin 29 of the wishbone 21. The primary part 30 of the linear motor 27 is secured to the vehicle body 22. The longitudinal direction of the linear motors 27 extends transversely to the travel direction FR. Provided in parallel relationship to the linear motor 27 are two coil springs 31 which are placed in series and connected to opposite sides of the wishbone pin 29, to thereby link the wishbone pin 29 to the vehicle body 22. Of course, it is also conceivable to replace the coil springs 31 by rubber springs or leaf springs.

The linear motor 27 is connected to a controller 33 via wire connections 32. The controller 33 is operatively connected to a sensor unit 34 for signal transmission. The sensor unit 34 is mounted to the vehicle body 22 in proximity of the guiding joint 24. The sensor unit 34 includes an acceleration sensor 35 for detecting acceleration in length directions of the linear motor 27. The controller 33 is further operatively connected to a control unit 36 which allows an operator to adjust the control behavior of the active arrangement 26 via a variable transformer 37 and a switch 38.

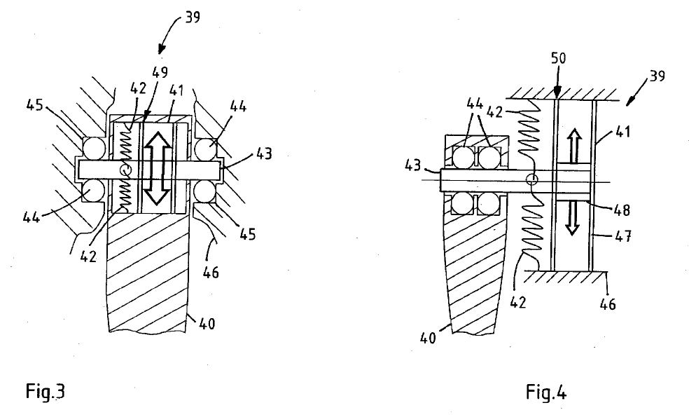

FIGS. 3 and 4 show two possible embodiments of an active arrangement for chassis manipulation and oscillation damping, designated here by reference numerals 49, 50, respectively, and positioned, by way of example, at a bearing 39 of a wishbone 40. FIG. 3 shows hereby an integrated active arrangement 49, whereas FIG. 4 shows an external active arrangement 50.

In integrated configuration, as shown in FIG. 3, the active arrangement 49 is disposed inside the wishbone 40 and has a linear motor 41 and two coil springs 42 placed in parallel relationship. Rubber springs or leaf springs may hereby be used instead. The coil springs 42 are coupled to a bearing axle 43 which extends transversely through the wishbone 40. The bearing axle 43 is supported by two ball bearings 44 upon the vehicle body 46, with the ball bearings 44 mounted on both sides of the wishbone 40 in pockets 45 of the vehicle body 48. Instead of ball bearings 44, it is, of course, also conceivable to use sliding bearings.

FIG. 4 shows an external configuration of the active arrangement 50. Parts corresponding with those in FIG. 3 are denoted by identical reference numerals and not explained again. The description below will center on the differences between the embodiments. In this embodiment, the active arrangement 50 is disposed to the side of the wishbone 40 and has a linear motor 41 with a primary part 47 mounted to the vehicle body 46, and a reactive part 48 rigidly mounted to the bearing axle 43. Two coil springs 42, which may be replaced by rubber springs or leaf springs, are placed in parallel relationship to the linear motor 41 and positioned in series. The coil springs 42 connect to opposite sides of the bearing axle 43 and extend transversely through the wishbone 40. Disposed inside the wishbone 40 are two ball bearings 44 which are placed upon the bearing axle 43. Also in this variation, the ball bearings 44 may be replaced by sliding bearings.

In all embodiments, the arrangement 7, 26, 49, 50 is constructed to actively influence chassis manipulation and oscillation damping of the wheel guidance 1, 20, using the linear motors 8, 27, 41. Targeted positioning of the reactive part 9, 28, 48 allows modification of track values of the chassis. In the event of a twist beam axle, shown in FIG. 1, the effect can be amplified through shifts of the anchor pins 10 on both bearings 5 in opposite directions by means of the linear motors 8.

Natural oscillations during operation of the wheel guidance 1, 20 are detected by the acceleration sensors 16, 35 in sensor units 15, 34, and after evaluation by the controller 14, 33, are interfered with a compensation oscillation via the linear motors 8, 27, 41. As a result, a periodic vibration of the wheel guidance 1, 20 is generated to suppress or damp or shift or decouple the oscillation in a suitable phase position. Bothersome oscillations caused during operation can thus be eliminated directly at the site of origin, resulting in an oscillation damping and damping of structure-borne sound. Vibrations of the wheel guidance 1, 20 are no longer transmitted onto the vehicle body so that the comfort for occupants is significantly increased during travel.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A wheel guidance, comprising:
at least one bearing for articulation of a trailing arm or wishbone to a vehicle body;
an active arrangement, operatively connected to the bearing and having a plurality of linear motors, for chassis manipulation and oscillation damping, said linear motors being constructed to operate in different directions; and
a controller operatively connected to the linear motors.

2. The wheel guidance of claim 1 for use in a motor vehicle.

3. The wheel guidance of claim 1, wherein the active arrangement includes at least one acceleration sensor which is secured to the vehicle body.

4. The wheel guidance of claim 3, wherein the active arrangement includes a controller operatively connected to the acceleration sensor for signal transmission.

5. The wheel guidance of claim 1, wherein the active arrangement includes spring members for interaction with the assembly.

6. The wheel guidance of claim 5, wherein the spring members are placed in parallel relationship to the linear motors.

7. The wheel guidance of claim 5, wherein the spring members are placed in series to the linear motors.

8. The wheel guidance of claim 5, wherein the spring members are selected from the group consisting of rubber spring, helical spring, leaf spring, pneumatic damper, and hydraulic damper.

9. The wheel guidance of claim 5, wherein the spring members are mounted on one side or on both sides of a bearing axle in a direction parallel to a length axis of the linear motors.

10. The wheel guidance of claim 1, wherein the linear motors are constructed to operate on the principle of electromagnetic propulsion.

11. The wheel guidance of claim 10, wherein the linear motors have a secondary part which is coupled to a bearing axle.

12. The wheel guidance of claim 1, wherein the linear motors include piezoceramic actuators.

13. The wheel guidance of claim 12, wherein the piezoceramic actuators form a staple actuator.

14. The wheel guidance of claim 1, wherein the active arrangement is constructed for adjustable control characteristics.
